(19) United States
(12) Patent Application Publication
(10) Pub. No.: US 2011/0277234 A1
(43) Pub. Date: Nov. 17, 2011

(54) PATIENT TRANSFER SHEET

(76) Inventor: Yogen J. Jasani, Liverpool (GB)

(21) Appl. No.: 13/131,795

(22) PCT Filed: Nov. 30, 2009
(86) PCT No.: PCT/GB2009/051620

§ 371 Date: Aug. 2, 2011

(30) Foreign Application Priority Data
Nov. 29, 2008 (GB) 0821856.2

(51) Int. Cl. A61G 7/10; G06K 1/00

(52) U.S. Cl. 5/81.1 R; 234/1

(57) ABSTRACT

Disclosed is a patient transfer sheet comprising a base material to which is applied a relatively low-friction surface, the patient transfer sheet comprising a plurality of apertures between opposed surfaces of the sheet for the purpose of allowing the passage of air from one side to the opposed side.

In a hospital or other care environment, such as a nursing or residential care home, there can be problems associated with moving patients who spend much or most of their time immobile on a bed. The same problem is experienced when transferring a patient to a trolley or gurney from their bed (or vice versa).

With larger or overweight patients, the risk of injury to the patient and/or the nurses/assistants is increased, and various techniques have been employed to ease the move process. A particular technique which has been found to be effective in some cases involves the use of a friction reducing sheet, sliding sheet or low friction transfer sheet, also known as repositioning sheet/devices or glide sheets. Such sheets or devices can improve patient safety and can reduce the risk of injuries to care staff.

One of the areas in which a care giver is most likely to be injured is when they are positioning and/or re-positioning a patient in a bed or when they are performing a transfer of a patient to/from a bed.

Sliding sheets are also found in use in industry. For example, in the freight forwarding and logistics industry, such sheets can be used in the positioning and placement of freight pallets. However, in the health care area, sliding sheets in the prior art are composed of a thin, tight-woven, synthetic fabric, usually polyester or nylon, to which a transfer coating or a laminated film is applied. In use, the opposed surfaces of the coated or laminated fabric contact each other with the effect that very low friction/resistance is experienced between the similar materials. In the description which follows, “transfer coated fabric” or “coated fabric” can include laminated film fabric also.

In use, the coated fabrics work best when they are in contact with a similar material, i.e. when one coated surface is in contact and sliding across another similar coated surface. However, sliding sheets can work on very highly polished surfaces such as high gloss, metallic surfaces or highly polished wooden surfaces.

Prior art sliding sheets composed of polyester or nylon are often known as reusable sliding sheets because they are capable of being washed and can be used many times over. These fabrics can be either knitted or woven or they can be made in various other fashions also.

Other prior art sliding sheets are known as disposable or patient specific (single patient) sliding sheets. In these cases, the sliding sheet is designed for multiple uses as a repositioning and transfer device for a single identified patient (or care-receiver). The patient specific sliding sheets are disposed of when they become soiled and/or damaged, and/or are no longer required by that particular patient.

Such disposable sliding sheets and patient specific sheets can be made from a non-woven material or they can be made from various types of plastics materials or from any other material. The use of disposable/patient-specific sliding sheets has increased in recent times due to concerns and issues regarding infection control, cross-contamination and patient hygiene.

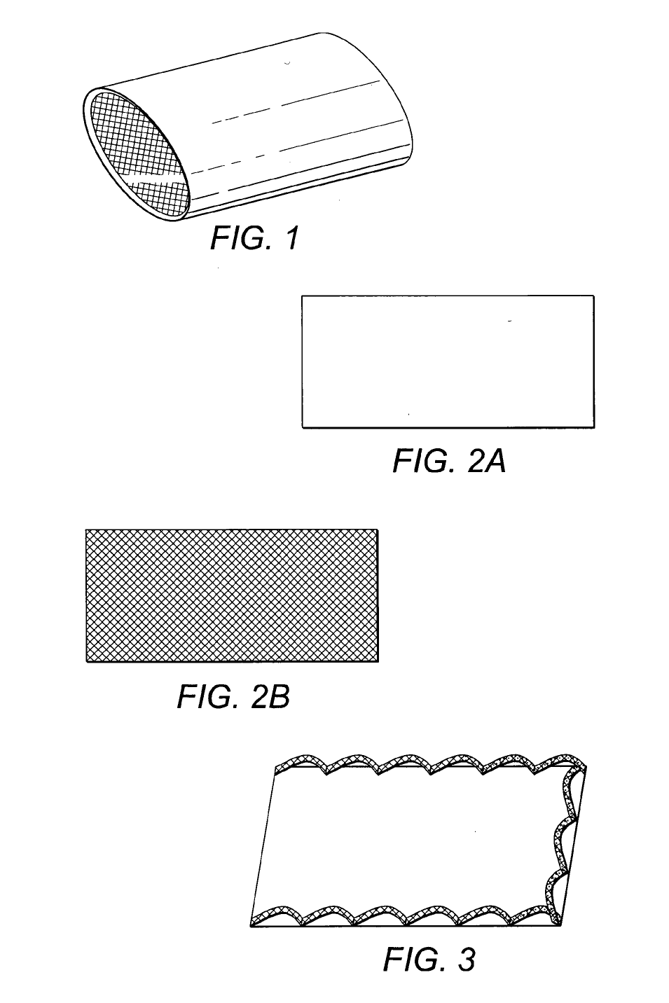

Returning to reusable sliding sheets, these are typically available in two different forms. Firstly, they are available as continuous tubes as shown in FIG. 1. FIG. 1 shows a cut length of such a tube where the transfer coated fabric is sewn to itself along opposed edges to produce a tube. In the example shown in FIG. 1, the tube is continuous, so-called because it can be rolled continuously on itself. It is also sometimes known as an endless tube. It is sewn such that the coated surfaces face each other inside the tube and can therefore slide across and against themselves.

In some cases, the tubes will have handles sewn or otherwise fastened along the outer perimeter of the tube. Such handles are used as grab and hold devices and can be used to facilitate a better grip in repositioning or transferring a patient.

Secondly, reusable sliding sheets may be provided as single, flat sheets as shown in FIGS. 2a and 2b of the attached figures. FIG. 2a shows the non-coated surface of the reusable sliding sheet and FIG. 2b shows the opposite side of the fabric to which the coating has been applied. Flat sheets with coating on one side are used in the repositioning and/or transfer of a patient. In this situation, two such flat sheets are used by sliding the coated surface of each sheet across and against each other or, alternatively, the sheet can be folded in half so that the coated surface contacts itself to achieve the same effect.

Sometimes, such reusable flat sheets will have handles sewn on the outer perimeter of the sheet. The handles can be provided on two opposed sides or, often, on three sides as shown in FIG. 3. These handles can be used as grab and hold devices and also to facilitate a better grip in repositioning and/or transferring a patient. Another form of sliding sheet available in the prior art is known as a unidirectional sheet (UDS). With this type of sheet, also known as “lock and glide”, relative movement between surfaces of the sheet is possible in one direction only. The movement is effectively locked in one direction and enabled in the opposite direction.

The ‘lock’ is achieved by provision of one or more bands of a material having a nap which tends to provide easy movement in one direction and greater friction in an opposed direction.

Such devices are used, for example, in wheelchairs, in seats, in chairs, in beds etc. On a chair, for example, the patient can sit on the UDS and the UDS will prevent the patient from sliding because the UDS will allow movement in only one direction.

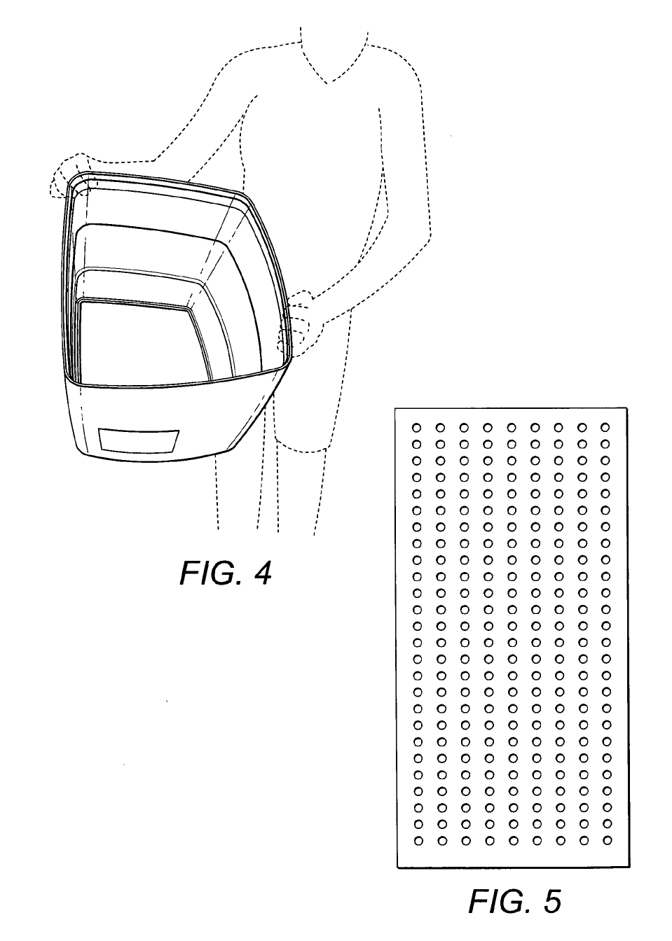

The outer cover of the UDS is usually made from a non-slip material to prevent the sheet from slipping and sliding and further counteracts any movement from the patient. If the patent should slouch and/or slip or slide along the seated area, the patient can be pulled up because the sheet will allow movement only in a single direction and in this instance, back to the back support of the seat or chair. This is shown in FIG. 4.

By moving the patient back into their seat, the lock and glide material slides easily over itself. However, once the patient is in the desired position, the opposed nap or textures of the material tends to hold the UDS and hence the patient in that position.

Any of the above mentioned sliding sheets, whether reusable or disposable, can also be provided with padding. For instance, some sheets will have polyester (or any other type of natural and/or synthetic and/or blend or mixture of various types of fibres or any type of composition) fibre filling. Such a filling is also sometimes known as hollow fibre. The filling may be kept in place by sewing lines across the sheet and quilting is also used for large surface areas.

Furthermore, any of the above mentioned sliding sheets can also be combined with other sorts of materials. For example, a fleece material may be quilted and/or laminated onto the sliding sheet material to improve patient comfort.

However, a problem with all of the above mentioned sliding sheets of whatever form is that they do not allow the movement of air. That is, none of them is breathable because they are all essentially coated and/or laminated with chemicals, films etc. that provide for the friction reducing properties of the sliding sheets but which do not allow the passage of air. This problem manifests itself in that areas of sliding sheets that are in contact or close to a patient can generally build up a lot of heat and can also build up an excess of body fluids including sweat and perspiration. This can limit the amount of time that a patient can be in contact with or close to a sliding sheet because hot, moist, enclosed areas around the body can be the cause of major skin and health problems including ulcers, aggravated pressure sores etc.

There is a train of thought in regard to prior art sliding sheets that padded sliding sheets can reduce the problems mentioned above and can help circulate the air. In fact, they can increase the amount of heat build-up because they “capture” heat that is displaced from the body and then maintain that heat in the confines and pockets of the padded material, thereby aggravating the problem. The UDS mentioned previously can also be uncomfortable because the patient will typically have to lie or sit upon such a device for many hours and there is very little movement of air in the region of the device. This is especially true if they are used in any textile covered seat, or padded furniture, or in a mobility appliance (e.g. wheelchair) or if they are used in beds. Typically, the amount of heat build-up is quite substantial and is not generally in the patient's best interest. The increased heat build-up could be due to layers that may be placed on the patient's body (for example blankets, rugs, duvets etc.) that would increase the heat build-up and reduce the air circulation around the patient's body. Another area of concern is the use of sliding sheets with bariatric patients. It is very difficult to put sliding sheets in place beneath such large, heavy patients and because of that, once a sliding sheet is beneath such a patient, often the sheet will stay in place for extended periods of time and this can cause the problems alluded to previously.

Furthermore, sliding sheets are generally not particularly comfortable to lie upon because they are typically made from synthetic materials. It is an aim of embodiments of the present invention to address the problems set out above in relation to prior art sliding sheets and to alleviate in particular the problems associated with the non-breathability of such articles. Other problems, whether mentioned herein or not, are also addressed by embodiments of the present invention.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

FIG. 1 shows a ‘continuous’ sliding sheet according to the prior art;

FIGS. 2a and 2b show opposed surfaces of a prior art sliding sheet;

FIG. 3 shows a prior art sliding sheet comprising grab handles;

FIG. 4 shows a UDS according to the prior art; and

FIG. 5 shows a sliding sheet according to an embodiment of the present invention.

In order to address the problems set out in relation to prior art sliding sheets it is desirable to provide a sliding sheet in a form that is breathable, i.e. one that allows at least a limited passage of air through from one surface to the opposing surface. Previously, this was not thought to be possible due to the inherent nature of the sliding sheets themselves and the fact that the low friction surfaces provided were not inherently breathable or porous. A particular solution has been found to this problem by manufacturing a plurality of apertures in a sliding sheet similar to that provided in the prior art.

It is instructive to look at a process that is used to manufacture a typical sliding sheet, but it is noted that practically any prior art sliding sheet can be used as the basis for an embodiment of the present invention and the following is exemplary only.

In a preferred embodiment the base fabric is made from a blend of nylon fibres. Nylon is generally preferred over polyester and other similar synthetic fibres because it is found that the nylon yarn is more robust and more rigid. This is advantageous especially in the chemical combination process by which the sliding property is added to the fabric.

The process by which the sliding property is added to the base fabric is performed at a temperature of approximately 150° C. It is found that, in fact, polyester is more stable at this temperature but only marginally more so than nylon, and nylon has other advantages which render it more suitable for this particular purpose. The high temperature of 150° C. is required to enable the combination of required chemicals with the base fabric and also improves the stability of the final fabric. The sliding sheets will inevitably be washed in commercial laundries and they will be subject to relatively high washing and drying temperatures. The high temperature used in manufacture ensures that the relatively lower temperatures used in normal fabric care are less likely to damage the sliding sheets.

The necessary materials which are required to provide a low friction surface may be applied to the base fabric by one of three different techniques. These are transfer coating, laminating or spraying. In addition, a combination of two more of these may be used in particular circumstances.

Typically, a method of applying a particular chemical to a fabric is by immersion, similar to dyeing. Furthermore, the required chemicals may be sprayed on or printed onto the base fabric. However, these techniques are found to offer short-lived benefits and do not ensure longevity since the chemicals applied in this way are generally washed away after only two or three washes of the sliding sheets.

In order to manufacture sliding sheets which can be re-used and laundered over and over, one or more of the two other techniques may be used. These are, as mentioned, transfer coating or laminating, as these yield re-usable, durable sliding sheets.

The chemicals which are required to provide the low friction surface are mixed together with polyurethane. The mixture of chemicals then extruded to make a film. Polyurethane is preferred to other candidate materials (e.g. PVC) because of its properties of durability, flexibility and ease of binding.

The film comprising the requisite chemicals and polyurethane can then be either transferred onto to the nylon base fabric or it can be laminated onto the nylon. In both of these processes, the film comprising the required chemicals is combined with the base fabric to form a unitary sheet. It is found that the relative rigidity of the nylon yarn is useful and assists in the transfer or lamination process.

The chemicals which are required as part of the polyurethane film to provide the low friction surface typically include silicones. Other suitable materials include petroleum based substances, but any material offering a substantially low frictional property will suffice.

But at high temperatures and with increased frequency of washing and drying, the film, whether transferred or laminated onto the base fabric, tends to flake and wash away, thereby reducing the utility of the sliding sheet as the low friction surface is removed.

To counter this particular problem, an additional process is found to be useful. The additional process melts the PU film into the nylon fabric. It essentially acts as a fusion of the film the chemicals which offer the low friction surface and the base fabric. The melting process is initiated after the film has been transferred and/or laminated onto the nylon base fabric and is achieved by passing the combined fabric with the chemicals in the film through an oven at high temperature. This causes the PU film to melt into the nylon base fabric so that the film is now an integral part of the nylon fabric i.e. it is fused into the yarn of the fabric to produce a chemically enhanced nylon fabric.

Other techniques may be employed, but the desired effect is for the chemicals which provide the desired properties to be fused into the fabric. It is also found that by appropriate choice of chemicals introduced into the PU film, other desirable properties can be applied to the sliding sheet. These include anti-microbial properties, anti-static properties and water-repellent properties.

The apertures which are required can be of any shape, size, dimension, thickness etc. For example, they can be configured to be rectangular, circular, oblong etc. They can be configured to be long and thin, e.g. linear strips. They can be big, small and in fact of any size. The most important factor in their construction is that they provide a passage from one side of the sliding sheet to the opposing side.

The apertures which are to be provided can be formed in the sliding sheet by any suitable means. For instance, it is found that electrical, chemical or mechanical means are particularly suitable for creating such apertures.

It is found that circular holes can be created in the sliding sheet material by use of a laser. Laser cutting devices are routinely used in fabric manufacturing/handling and suitable devices are readily available.

Mechanical means can be used in the form of a press which can be used to punch holes in the fabric as it passes through the press.

Chemical means can be used by applying a suitable corrosive material (e.g. acid) to selected areas of the sliding sheet. In fact, a technique similar to an inkjet printer can be used to selectively apply a defined pattern of perforations using such a corrosive material which is ejected onto the sliding sheet as required.

In practice, it is found that creating the apertures in the material by use of a laser produces the best results as the action of the laser tends to cauterise or seal the hole around its circumference, which can increase the longevity and durability of the sliding sheet, especially after it has passed thorough several laundry cycles. In the absence of this, the holes can tend to fray which can introduce an area of weakness.

FIG. 5 shows a sliding sheet which has been perforated according to an embodiment of the invention. The number and size of apertures may be selected as required. Typical aperture dimensions are in the range

As well as making the material breathable by effectively perforating it, the breathability can be further enhanced by the use of natural fibres in its manufacture. This has the effect of improving patient comfort. Suitable natural fibres may be selected from: cotton, viscose, jute or any other suitable natural fibre.

Suitable materials may also be prepared by mixing natural and synthetic fibres. Suitable examples include: polyester cotton; nylon cotton; polyester, viscose, cotton; nylon, viscose, cotton; polyester viscose; or any suitable combination of any type of synthetic material (including fibres, compounds etc.) with any type of natural fibre.

The blended fibres can help to improve patient comfort and can also help with easy acceptance of their use due to their similarity with what patients are used to anyway.

For instance, sliding sheets made from a mix of polyester and cotton mimic bed sheets in that they feel and work in a very similar way to bed sheets used at home by patients.

It is found that a combination of adding apertures to the sliding sheet and altering the formulation of the base sheet offers advantages in providing a breathable material which alleviated many of the problems encountered with prior art sliding sheets.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A patient transfer sheet comprising a base material to which is applied a relatively low-friction surface, the patient transfer sheet comprising a plurality of apertures between opposed surfaces of the sheet for the purpose of allowing the passage of air from one side to the opposed side.

2. The patient transfer sheet of claim 1, wherein the base material is one of a natural fibre and a synthetic fibre.

3. The patient transfer sheet of claim 1 wherein the base material is nylon.

4. The patient transfer sheet of claim 1 wherein the relatively low friction surface comprises one of a silicone material and a petroleum based substance.

5. The patient transfer sheet of claim 4 wherein the silicone material or petroleum based substance forms part of a film which is applied to the base material by means of transfer coating or laminating.

6. The patient transfer sheet of claim 5 wherein the film comprises polyurethane.

7. The patient transfer sheet of claim 1 provided in the form of a cylinder whereby the relatively low friction surface is provided on an interior surface of the cylinder.

8. The patient transfer sheet of claim 7, wherein there is additionally provided a material on the interior surface of the cylinder which permits relatively easy movement in a first direction and relatively little movement in an opposed direction.

9. A method of manufacturing a patient transfer sheet, comprising the step of providing a base fabric with one surface having relatively low friction and comprising the further step of perforating the sheet to provide a plurality of apertures between opposed surfaces of the sheet.

10. The method of claim 9 wherein the step of perforating comprises the use of a laser.
